(19) United States
(12) Patent Application Publication
(10) Pub. No.: US 2018/0330321 A1
(43) Pub. Date: Nov. 15, 2018

(54) ELECTRONIC TRACKING AND MONITORING OF TRANSIT AND CONDITION STATUS OF BIOLOGICAL PRODUCTS

(71) Applicants: Franco Ivan CAPELLI, Cusago (IT); Jim MANOLIOS, Victoria (AU); Raoul CADEI, Varese (IT)

(72) Inventors: Franco Ivan CAPELLI, Cusago (IT); Jim MANOLIOS, Victoria (AU); Raoul CADEI, Varese (IT)

(21) Appl. No.: 15/779,422

(22) PCT Filed: Nov. 25, 2016
(86) PCT No.: PCT/AU2016/000387

§ 371 Date: May 25, 2018

(30) Foreign Application Priority Data
Nov. 25, 2015 (AU) 2015904881

(51) Int. Cl. G06Q 10/08; G06K 7/10

(52) U.S. Cl. CPC G06Q 10/0833; G06K 7/10366

(57) ABSTRACT

A method for tracking biological products from a source to a destination, the method comprising the steps of; a) identifying and compiling data related to characteristics and identity of a product; b) taking a container capable of holding the biological product and including with the container a device capable of transmitting and/or receiving and/or storing data related to the product; b) uploading the data into the data storage device associated with the product; c) providing at least one data reader capable of reading data stored in and/or transmitted from the storage device; d) transporting the product from an origin to a predetermined destination; e) during transmission from the origin to the destination, monitoring location and condition parameters of the product.

### BACKGROUND

The present invention relates generally to electronic tracking and condition monitoring of articles and more particularly to electronic tracking and monitoring of biological goods including, but not limited to, packaged blood products. The invention further relates to systems and methods for detecting, tracking, processing and monitoring of location status of articles including blood products used in transfusion medicine and condition status of such products, such as, but not limited to environmental conditions including temperature history.

### PRIOR ART

There are inexistence a variety of electronic tracking systems used for tracking the progress of an article through a processing system. Such systems have been used previously in mail and parcel tracking systems. Once such example of a tracking system for mailed articles is disclosed in U.S. Pat. No. 6,032,138 which is incorporated by reference herein. This patent discloses a system in which relevant mail information is uploaded periodically to a data centre. The recipient addressee of a mail article can configure a digital postage meter or mail processor to read digital recipient data. If received unique identifiers or codes match with the send unique identifiers or codes, the codes cancel out.

in another example of the known art, International publication No. WO 02/101505 discloses a method and system for cross carrier parcel tracking. The system enables a carrier of a mail article to track a mail piece as it passes from the control of a first carrier to the control of another carrier. The tracking continues until the mail is delivered by a second carrier to its ultimate recipient. The first carrier who had control of the mail piece when dispatched, can continue to monitor the progress of the mail piece through the delivery system to the recipient via the second carrier. The system described is particularly useful in seeking to track delivery performance of internationally addressed mail that is first domestically posted and delivered to a foreign country.

None of these described systems have nor teach the use of an intelligent package which monitors condition data concerning its real time condition during processing from origin to destination. This facility is not found in mail processing as there is no critical imperative to know of the condition of the mailed article.

In transfusion medicine, packed red blood cells (sometimes called stored packed red blood cells or packed cells; red blood cells (RBC), are also called erythrocytes) that have been collected, are processed, and stored in bags as blood product units available for blood transfusion. The collection may be from a whole blood donation followed by component separation, or by RBC apheresis. The processing/manufacturing of the biological product and its storage can occur at a collection center and/or a blood bank. RBCs are mixed with an anticoagulant and storage solution which provides nutrients and aims to preserve viability and functionality of the cells which are stored at refrigerated temperatures for up to over one month or they may be frozen for longer periods extending to years. Cells are separated from the serum of the blood after it is collected from a donor, or during the collection process. The blood product may be then sometimes modified after collection to meet specific patient requirements. RBCs are used to restore oxygen-carrying capacity to the blood of a patient that is suffering from an anemia due to such conditions as trauma or other medical problems and are by far the most common blood component used in transfusion medicine.

The process of identifying a compatible blood product for transfusion is complicated. Administering incompatible RBCs to a particular patient can be fatal. To avoid transfusion reactions, the donor and recipient blood types are tested (cross matched) Finding suitable blood for transfusion when a recipient has multiple antibodies or antibodies to extremely common antigens can be very difficult and time consuming Because this testing can take time, doctors will sometimes order a unit of blood transfused before cross matching can be completed if the recipient is in critical condition. Typically two to four units of O negative blood are used in these situations, since they are unlikely to cause a reaction. Non cross matched blood is only used in dire circumstances. Since O negative blood is not common, other blood types may be used if the situation is desperate.

It is essential to maintain the quality of the packed blood cells throughout their life until used. Most frequently, whole blood is collected from a blood donation and is spun in a centrifuge. The red blood cells are denser and settle to the bottom, and the majority of the liquid blood plasma remains on the top. The plasma is separated and the red blood cells are kept with a minimal amount of fluid. With additive solutions, RBCs are typically kept at refrigerated temperatures for up to 42 days. In some patients, use of RBCs that are much fresher is required. For example, US guidelines call for blood less than seven days old to be used for neonates, to ensure optimal cell function.

However, the phenomenon of RBC storage and its implications for transfusion efficacy are complex. Frozen RBCs are typically assigned a ten-year expiration date. The freezing process is expensive and time-consuming and is generally reserved for rare units such as ones that can be used in patients that have unusual antibodies. In all cases it is essential that the practitioner administering the blood products can be confident that it has not been compromised, contaminated, degraded or expired and unsuitable for use.

In modern transfusion practice, blood donations are collected in the field, at hospitals or via mobile collection centres. The blood donations are then transported to a central processing centre where they are tested and processed to become transfusible blood units and other components (like concentrated platelets). The blood units have an effective life of 42 days after which time they must be discarded. The production of blood units requires a site which is licensed by the appropriate regulatory authority: for example, the Federal Drug Administration (FDA) in the USA or the Therapeutic Goods Administration (TGA) in Australia. Because the blood units are ‘dispensed’ in the sense that they are intended to be injected via transfusion into a patient, like pharmaceuticals, once the blood units leave the donor accreditation centre they cannot be taken back to the donor centre for reprocessing or reassignment. Once they are assigned to a specific hospital or transfusion laboratory they are considered to have been dispensed in a manner analogous to dispensing a drug for a particular patient. Because viable blood units are a limited resource and are usually needed urgently, (sometimes in large numbers at remote sites), having units ‘in the field’ is a vital necessity.

Unfortunately, due to the nature of emergency events they are usually in the wrong place or in insufficient quantities. Furthermore the need to have certain numbers of units pre-cross matched for patients undergoing routine surgery and the requirements that will occur randomly through the emergency ward means that hospitals must have significant volumes of blood units available at any one time, although more than likely most will not be needed.

This means that due to a lack of mobility a significant volume of blood units expire before they can be used, i.e. they stay in stock at one particular site until they expire. In many first world health care systems expired stock can account for more than 20% of the total blood units produced. Not only does this put extreme pressure on the volunteer blood supply but with a cost to produce of approximately AUD400 per unit, in Australia alone this equates to 200,000 units×400=AUD80,000,000 per annum.

Currently, information about a packaged biological product is contained on external labels on the product's container. Once the labels are applied, there is no facility for altering the data. Nor is it possible to determine from the package data the use, locations and transit, environmental, temperature and other condition history of the biological products. Further processing occurs at the hospital end to eventually assign the blood to a specific patient. Apart from the movement of blood as described above, there are several other processing steps within the hospital environment which can increase the risk of human errors.

According to current practice, the Transfusion laboratory in the hospital must firstly enter all the units into the laboratory information system manually. Each blood donation is re tested to confirm the group (as the Red Cross (donor organisation) takes no responsibility for incorrect labeling). This process creates an opportunity to confuse results at testing and at the point of data entry.

The process is time consuming and requires well trained personnel. The laboratory then either uses a computer cross match in which the accredited computer software system compares the Patient sample results with the Donor bag stock and assigns compatible blood to the patient electronically or a traditional cross match is performed where the patient's blood and the Donor Blood are combined to see if there is an adverse reaction. This process is rigorous. However it does not control the correct collection of the blood from the patient or the correct transcription of the results.

When all of the above testing has been performed in the laboratory, the blood bag once assigned, is then picked up by a nurse or orderly and taken to the patient bedside or operating theatre as required for the transfusion to occur. Again this is an opportunity for errors or even combinations of errors. The nurse must give the right patient the right blood bag. Australian hospitals have even introduced a system whereby 2 nurses must sign off, one checking the others work. In theory this is a safeguard, but in practice, many wards do not have sufficient staff and multiple transfusions are required at the same time to be administered by the same nurse. Once administered the nurse needs to complete paperwork to confirm use of the Blood bag. This paperwork is then sent to the Transfusion laboratory for verification of correct use and the overall data is then transmitted to the Donor Accreditation service. In practice this is not a timely process, is prone to errors and is only completed sporadically.

It can be seen that in the current system there is wide opportunity for errors from the donor accreditation, to and during transportation and within the recipient institution such as a hospital. Thus according to the current systems there is opportunity for unsafe provision of blood and for errors including but not limited to inaccurate data entry of biological product data.

There is a long felt want to improve the efficiency of the management, processing and use of biological products and especially blood products and to minimise or eliminate both processing errors and wastage of stock that currently must be deemed to be expired arising from lack of knowledge of its geographic and environmental history, occasioning the associated financial loss arising from disposal. There is a long felt want in the industry to provide improvements in efficiency of processing of blood products to accommodate the wide variety of circumstances in which RBC's are required such as but not limited to trauma and elective surgical procedures.

There is also a need to more efficiently track and monitor biological product condition parameters, environmental conditions in which the product has existed during its life, its transport and donor history. There is also an increasing need to protect the valuable resource of blood donations so that better use can be made of the limited resource before expiry or degradation during transit or storage. There is a further need to ameliorate or eliminate economic losses currently occurring in the biological products industry and also to provide practical advantages over the known art.

### INVENTION

The present invention in one broad from provides a method for processing, transporting and tracking of biological products from an origin to a destination to ensure the integrity of the product from data records captured on a product data base. According to the method there is provided a receptacle for containing biological product and which includes means integral therewith or detachably connected thereto to enable tracking, including real time tracking and monitoring of biological condition parameters of the biological products and geographic history of the receptacle, bag or other container in which the products are placed.

More particularly the invention further provides a biological products bag which is monitored as it is transported from donor to recipient so that personnel can ascertain accurate data parameters regarding the transport and environmental history of the product, packed cell blood bag including integrated intelligence including a device having at least data receiving and/or storage and/or transmission capacity to enable interactive transfer of data to and from the data storage means for the purpose of tracking and monitoring a potentially unlimited number of parameters of a potentially unlimited number of containers of biological products including but not limited to, identity of the container/bag, its contents, status of its contents, its location, its age, temperature history, transit activity, biological condition parameters, donor data, recipient patient data, institution data and tracking activity.

The invention further provides a tracking method and support system for communication with the intelligence and more specifically the data storage means thereby allowing locally or from a remote location the adjustment, augmentation, deletion of data from a potentially unlimited number of biological product containers. The invention in another broad form provides a biological product bag/container which includes integrated intelligence allowing data input, output, detection; collecting, processing and monitoring of status of the container and/or its contents particularly though not exclusively when used in processing of packed cell blood products used in transfusion medicine.

In one broad form of an apparatus aspect, the present invention comprises: a biological products container which receives and retains therein a biological product, the container having associated therewith; an electronic data storage device capable of at least receiving, and/or storing and/or transmitting data related to the characteristics, condition parameters, environment and storage history of the biological product;

According to one embodiment, the device includes an electronic readable memory, an antenna, and at least one power source; the antenna capable of receiving and transmitting data related to parameters such as the donor history, the nature and/or location and/or condition of biological products contained in the bag.

Preferably, the power source is at least one battery. According to one embodiment, the electronic device is also capable of transmitting/delivering data regarding the characteristics of the product to a central controller or central data base. According to one embodiment, the electronic device is an erasable RFID tag or the like and is physically connected to the biological products bag/container. For example the tag may be connected via a tie, integrally connected to the bag or releasably inserted into a pocket in the bag.

In another broad form the present invention comprises:

a blood products bag for storing blood products, the bag including associated therewith an electronic device having a data storage memory, the bag capable of storing, receiving, transmitting data related to parameters of the biological product contained in the bag and a capacity to transfer the data to a data base at any time during the life of the blood products.

According to one embodiment the electronic device receives, stores, processes and transmits data relating to the nature and/or location and/or condition of the biological contents. The electronic device according to one embodiment is a storage device which holds data which is readable by a scanner or like device or the data can be down loaded for display.

According to one embodiment the data contained with the bag is readable direct form the bag via an electronic reader or readable remotely. According to a preferred embodiment there is provided in or one the bag an electronic chip allowing interactive transfer of data manually or automatically, wirelessly or via hard wire connection to enable a user to ascertain the status of the bag and its contents according to a data held related to a potentially unlimited number of performance, condition and/or location parameters. According to one embodiment the electronic intelligence includes a display monitor for user read out.

In its broadest form the present invention comprises;
a container for carriage and storage of biological products, the container including connected to or integral therewith integrated interactive intelligence which enables receipt and transmission of data related to identity, use and condition history of the container and its contents including but not limited to, the nature and/or location and/or condition of biological product/s contained in the container.

According to one embodiment the container is a bag for containing blood products such as packed red blood cells. According to one embodiment the integrated intelligence includes an electronic data storage, and at least one of a data receiver, a data reader and data transmitter, or any combination of those, a power source and an antenna for receiving and transmitting data.

In another broad form the present invention comprises: an electronic tracking system enabling real time tracking of at least the identity, source, condition, use history, location and integrity of biological products contained in a transportable container, the system comprising:
a container for holding biological products, electronics associated with the container which includes at least data input means, a memory for storing data, a data receiver, data storage, a data reader and data transmitter; a power source and an antenna which enables receiving and transmission of data related to the biological contents, wherein, the system allows real time local or remote monitoring of at least one or more of the parameters of identity, source, condition, use history, location and integrity of biological products.

According to one embodiment the data reader is a small hand held device capable of at least reading data for local user use and uploading to a central controller for remote access to data.

Throughout the description, a reference to biological products can be taken to mean a reference to any one of blood, blood products, bodily fluids, specimens, tissues, organs, biological samples, artificially produced tissues, specimens and organic products. Throughout the specification a reference to container can be taken to be a reference to a bag, receptacle, vessel, bottle, package or the like manufactured from any material and which is capable of holding any one or more of blood, blood products, organic material, bodily fluids, specimens, tissues, organs, biological samples, artificially produced tissues, specimens and organic products. Throughout the specification a reference to an electronic device can be taken to include an RFID tag, computer chip, portable drive, wireless receiver, memory card. Throughout the specification a reference to control station can be taken to mean a reference to a central controller, computer, monitoring station which is in communication with each stage of the tracking system, downloadable computer application. Throughout the specification a reference to condition parameters can be taken to be a reference to product age, temperature range and temperatures at specific times, quantity, type, transit time, transit history, used or unused.

The present invention provides an alternative to the limitations of the currently used identity labels and is primarily applicable to blood bags. It will be convenient to hereinafter describe the invention in relation to that exemplary application. However, it is to be appreciated that the invention is not to be construed as limited to that application. The invention is applicable in each of its forms to tracking and monitoring of any biological products for human or animal use and which degrade over time.

The invention provides a biological products bag which has the advantages of electronic intelligence including tracking with the extra costs of the bag electronics off set by the reduction in wastage of biological products as described earlier. The system according to its various embodiments, is relatively low cost and cable of implementation, globally, nationwide or within local regions and adaptable to any blood bag manufacturer. The Intelligent blood bag is when used or expired, disposable as per a normal blood bag which has been used or has expired.

In another broad from of a method aspect the present invention comprises:

a method for tracking biological products from a source to a destination, the method comprising the steps of;
a) identifying and compiling data related to characteristics and identity of a product;
b) taking a container capable of holding the biological product and including with the container a device capable of transmitting and/or receiving and/or storing data related to the product;
b) uploading the data into the data storage device associated with the product;
c) providing at least one data reader capable of reading data stored in and/or transmitted from the storage device;
d) transporting the product from an origin to a predetermined destination;
e) during time from the origin of the biological product to the destination for the biological product, monitoring location and condition parameters of the product;
f) verifying condition parameters of the product prior to administration of the biological product to a recipient.

Preferably the data is contained on a chip associated with a container or soft bag which holds the biological product. The data including data in the data storage device relates to parameters such as but not limited to characteristics of the biological product, location and location history, temperature, age of the product, source/origin of the biological product, the name of the donor, the type and nature of the product, transport history, real time locations, path/route of travel, product transmission/transport time, place of origin, name of donor, time of origination, transport path.

According to one embodiment, a reader is capable of reading data transmitted from the storage device in real time. A remote controller can be employed to receive and process data related to the biological product.

The source of the biological product is a blood donor and the recipient of the biological product is a patient who receives blood products such as serum and/or packed cells from a blood bag.

When a patient requires blood a practitioner is able to determine sufficient information from the data storage device associated with the particular product, a full set of parameters which enable a determination of whether the biological product should be treated as expired or capable of future use following a prior despatch in which the product was not used.

The invention further provides a biological products bag which can be retrofitted with electronic ‘intelligence’ to convert a currently labeled bag into an intelligent bag. The intelligent bag is quick and easy to manufacture, lightweight readily stackable and transportable.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying illustrations and descriptive matter in which there is illustrated various including preferred embodiments of the invention.

The present invention provides an alternative to the known prior art and the shortcomings identified. The foregoing and other objects and advantages will appear from the description to follow. In the description reference is made to the accompanying representations, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying illustrations, like reference characters designate the same or similar parts throughout the several views. The following detailed description is, therefore, not to be taken in a limiting sense, and the scope of the present invention is best defined by the appended claims.

### BRIEF DESCRIPTION OF THE DRAWINGS

The invention will be better understood and objects other than those set forth above will become apparent when consideration is given to the following detailed description thereof. Such description will now be described in more detail according to a preferred but non limiting embodiment and with reference to the accompanying illustrations wherein:

FIG. 1 shows an elevation view of a typical blood products bag for transportation and storage of packed blood;

FIG. 2 shows an elevation view of a blood products bag which includes an electronic device associated with the bag;

FIG. 3 shows an RFID tag according to a preferred embodiment isolated from the bag 4 of FIG. 2;

FIG. 4 shows a plan view of a scanner which enables reading of label indicia via the sample;

FIG. 5 shows an elevation view of the scanner of FIG. 4; and

FIG. 6 shows a schematic layout of the system aspect of the invention according to one non limiting embodiment.

### DETAILED DESCRIPTION

The present invention will now be described in more detail according to a preferred embodiment but non limiting embodiment and with reference to the accompanying illustrations. The examples referred to herein are illustrative and are not to be regarded as limiting the scope of the invention. While various embodiments of the invention have been described herein, it will be appreciated that these are capable of modification, and therefore the disclosures herein are not to be construed as limiting of the precise details set forth, but to avail such changes and alterations as fall within the purview of the description.

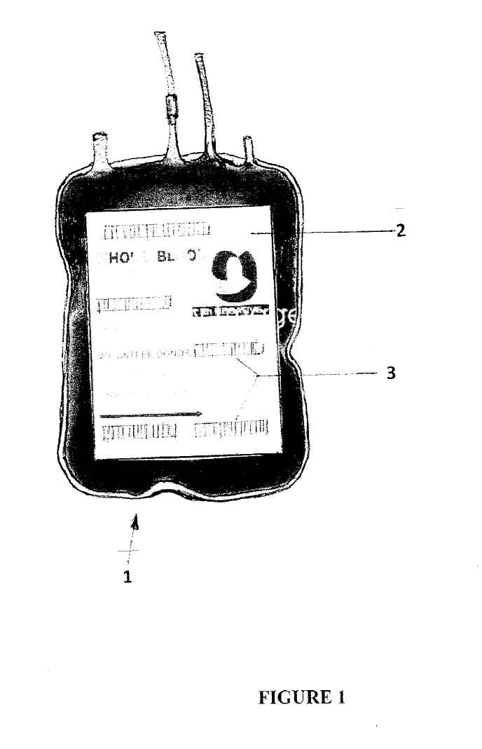

FIG. 1 shows an elevation view of a typical known/prior art blood products bag 1 used for transportation and storage of packed blood. The bag shown includes labelling 2 with a plurality of bar codes 3 which enable reading of ‘fixed’ data related to that bag and which cannot be updated or otherwise altered other than by manually changing the labels and/or bar codes which is not done in the current practice. Fixed data includes name of donor, name of donor institution, nature and type of contents, time and date of collection.

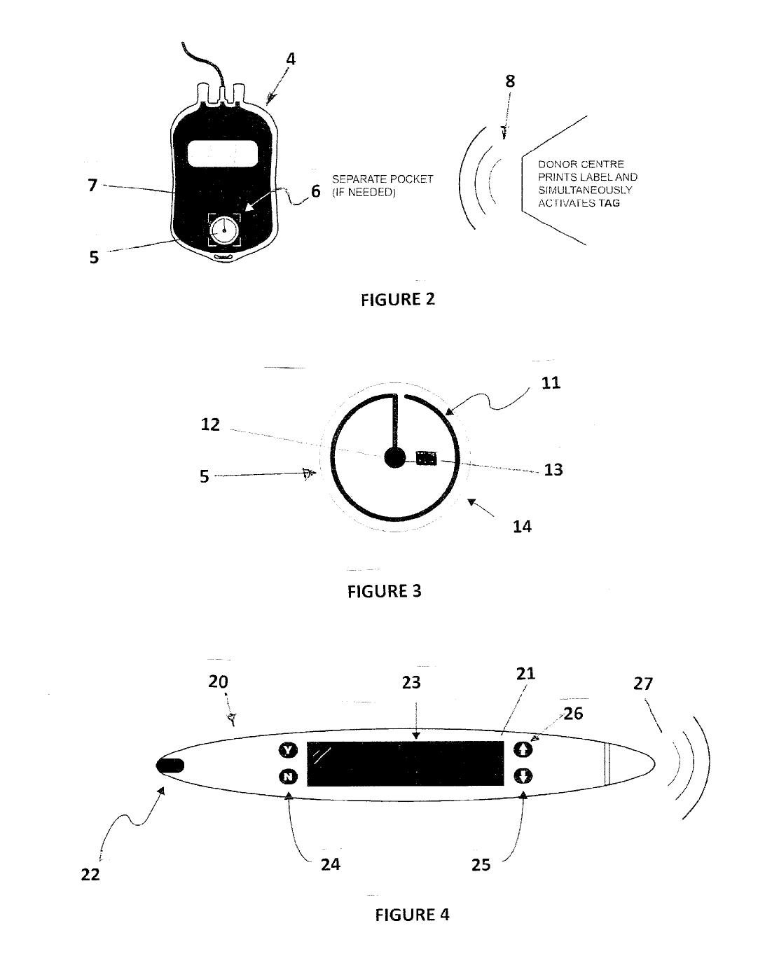

FIG. 2 shows a rear elevation view of a blood products bag 4 which includes an electronic device 5 associated with the bag. Electronic device 5 is inserted in pocket 6 formed in the wall 7 of bag 4. According to a preferred embodiment, the electronic device 5 of blood product bag 4 has intelligence comprising data storage and/or data transmission and/or data reading. Although the embodiment of FIGS. 2 shows the electronic device 5 inserted in pocket 6, the electronic device can be integrally connected with the bag 4 via an adhesive and reprogrammed for each use. Preferably the intelligent electronic device is an RFID tag, preferably comprising a body of flexible material which allows the tag to conform to the contour of the bag 4. Thus the electronic tag 5 can be built into the bag, placed on or attached to the bag, for example using an adhesive, at manufacture or retrofitted to existing bags. The electronic intelligence may be embodied in a computer chip included in RFID tag 5 or the like which provides access to the data for the product to which the electronic intelligence is attached. In practice, when a biological product is created, a chip and/or tag 5 is attached to the product. Tag 5 holds an initial set of data which includes such fixed data (i.e. data which will be non-variable for a particular biological sample) such as but not limited to name of donor, donor institution, product description, blood type, place of production/collection, time and date taken, volume.

Throughout the life of the product in bag 4 there will be a set of fixed data and progressively generated and stored sets of variable data as the sample moves through its transit to the recipient. For example, the biological product will gradually build data such as a temperature profile, time line, age location, history, so that an end user can assess the suitability of the product for future use. This is particularly useful when a biological product has been assigned for a particular use but is ultimately not used for that initial assignment. In that case, according to the prior art practices, the biological product will be treated as expired and discarded. The present invention allows a user such as a nurse practitioner or other authorised medical officer to determine sufficient parameters to enable an assessment of the integrity, identity and utility of the product within its maximum shelf life. Wireless transmission 8 indicates activation of tag 5 simultaneously with the printing of an identity label (see item 2 FIG. 1).

FIG. 3 shows an enlarged view of the Radio Frequency identification (RFID) tag 5 of FIG. 2 according to a preferred embodiment isolated from the bag 4. A suitable RFID tag 5 is selected for the particular applications described herein. The selection takes into account such parameters as tag operating frequency, memory capacity, tag range, how the tags will be used, their operating environment, surrounding materials that they could interact with. Typically (RFID) uses electromagnetic fields to automatically identify and track tags attached to objects. The tags contain electronically stored information. Passive tags collect energy from a nearby RFID reader's interrogating radio waves. Active tags have a local power source such as a battery and may operate at hundreds of meters from the RFID reader. Unlike a barcode, the tag need not be within the line of sight of a tag reader, so the tag 5 may be embedded in the tracked object. RFID allows for automatic identification and data capture.

RFID tags have been used for various tracking and identity verification operations. The tags can track objects through manufacturing processes and in warehouses. An example is pharmaceuticals tracking. RFID tags are also used for implant micro chipping of pets. The present invention integrates the use of electronic data collecting, storing and transmission devices with the unique process of biological products processing and particularly though not exclusively blood products processing to thereby enable accurate historical and real time tracking of the blood and its condition status.

According to one option, tag 5 includes an antenna 11 for temperature sensing. Since the tag 5 is to allow for remote data sensing/reading, a battery 12 is included which has an active life at least as long as the shelf life of blood products. Tag 5 further comprises a memory which stores all relevant data and product and bag information. Typically tag 5 will ideally be around 40 mm in diameter and 2-3 mm thick and include a chip 13 for Near Field Communications (nfc) and associated electronic circuitry to allow effective operation. Tag 5 includes a housing 14 which retains all of the aforesaid components.

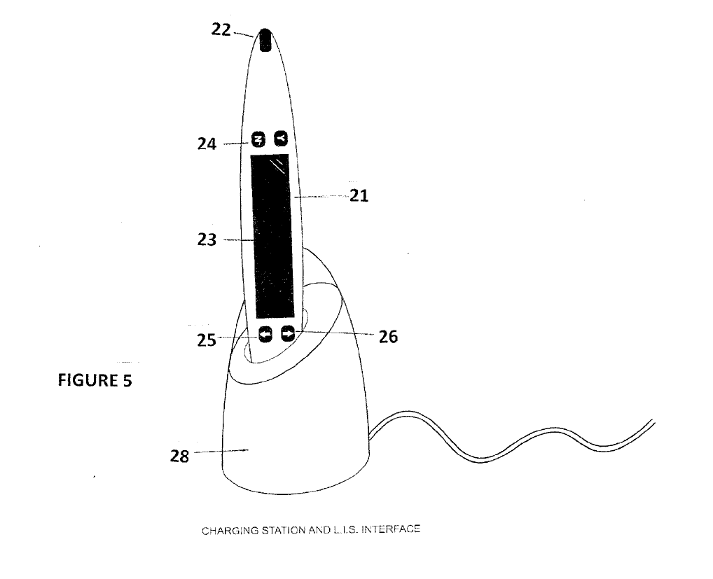

FIG. 4 shows a plan view of a reader/scanner 20 which enables reading of label 2 and/or tag 5 indicia via the sample. Scanner 20 according to one embodiment includes a body 21 and incorporated therein barcode scanning station 22 which receives and stores product data. Scanner 20 also includes a display 23 and control keys 24 which enable an operator to display product parameters. Scroll key 25 and 26 are provided to enable an operator to move between memory locations and to select particular data concerning the biological product. Scanner 20 includes an Nfc communications station 27 which allows transmission and receipt of data to and from a donor institution/station, a transit path, a recipient institution or to and from a central controller.

A central controller allows for remote monitoring at a central location of a potentially unlimited number of products. This allows another data base which can provide practitioners information to assess the integrity of the biological products. A central controller is capable of logging data related to a potentially unlimited number of product bags so that any one bag at any time can be ‘read’ to determine such parameters as bag identity, its source, its current location, its location history over a short or long term, its intended future location/s and estimated time of arrival, its contents type, associated patient data, use history and parameters associated with the biological product including but not limited to age, environment temperature history, including transit temperature ranges, and the institution and personnel (including a patient) to which the bag has been assigned.

Reader/scanner 20 allows personnel such as a nurse practitioner to determine necessary matching data (such as verifying that a patient is the correct recipient/assignee of that product), whether a biological product is fit for use (within its shelf life) and whether the environmental conditions to which the product has been subject are satisfactory to ensure that the product is not contaminated or degraded by excessive temperatures such as may be experienced in transit.

FIG. 5 shows with corresponding numbering, an elevation view of the scanner 20 of FIG. 4 located in a charging station 28. Charging station 28 is also capable of active transmission and receipt of data, via communications station 27 now seated inside charging station, wirelessly or via network cable, between a central controller station or to or from the donor and/or recipient institution.

Each bag 4 may be identified and tracked with reference to image capture and/or may be monitored using a data reader/scanner 20 capable of uploading product data direct from a data storage in a read memory, for use locally or for transmission to a central controller. According to one embodiment a typical bag will includes a pocket 6 which receives and retains therein a tag 5 having an electronic board/chip which includes a memory, data processor, electronic clock and electronic calendar. The memory includes a read /write capacity. Temperature monitor 11 is capable of storing the temperature data in a secure format for release to appropriate interrogation. The system allows for and enables reassignment as required to another location within a hospital or to another hospital or other institution/location. For each reassignment condition monitoring from real time data is available to a user.

According to one embodiment each bag includes a sealed or attached electronic board. In one version, the electronic board is sealed into pocket 6 in the bag 4 and includes capacity for direct or wireless connection to a reader for uploading or downloading of data. In another embodiment the bag intelligence is contained in a compact unit which is attached to bag 4. Preferably the electronic board is in the region of 2-4 mm thick and capable of holding in memory all data referred to above relative to the blood product data. Some of this data is currently held on a label applied to the external face of the bag. According to one embodiment, the central controller may be located at a blood bank or other suitable location or institution, such as a recipient hospital in which blood products are used.

The Intelligent Blood Bag is used as part of an integrated software and hardware package which will be capable of switching the bag on, loading it with the required data (geographical and condition parameters), monitoring its suitable transport in real time. Temperature and destination data is allocated to a specific patient or blood fridge within a hospital and informing a secure device handled by a trained professional whether the blood unit is being dispensed to the correct patient. All data may then be downloaded to a computer system associated with controller 12 capable of communicating with a hospital or the like, blood donor accreditation centre and/or central regulatory authority as required.

The intelligence with the blood Bag 4 is capable of knowing who donor is, what it contains, where it is going, if it has arrived, if it has been maintained at the correct temperature during transit, who it has been assigned to (i.e. which patient). Furthermore since the bag knows its own condition at any given time, the bag can be reassigned as required to another site within a hospital or to another hospital and the transport and assignment process can begin again under close monitoring. The intelligent electronic device may incorporate an electronic board is integrated built into the device all insertable into the pocket or sleeve.

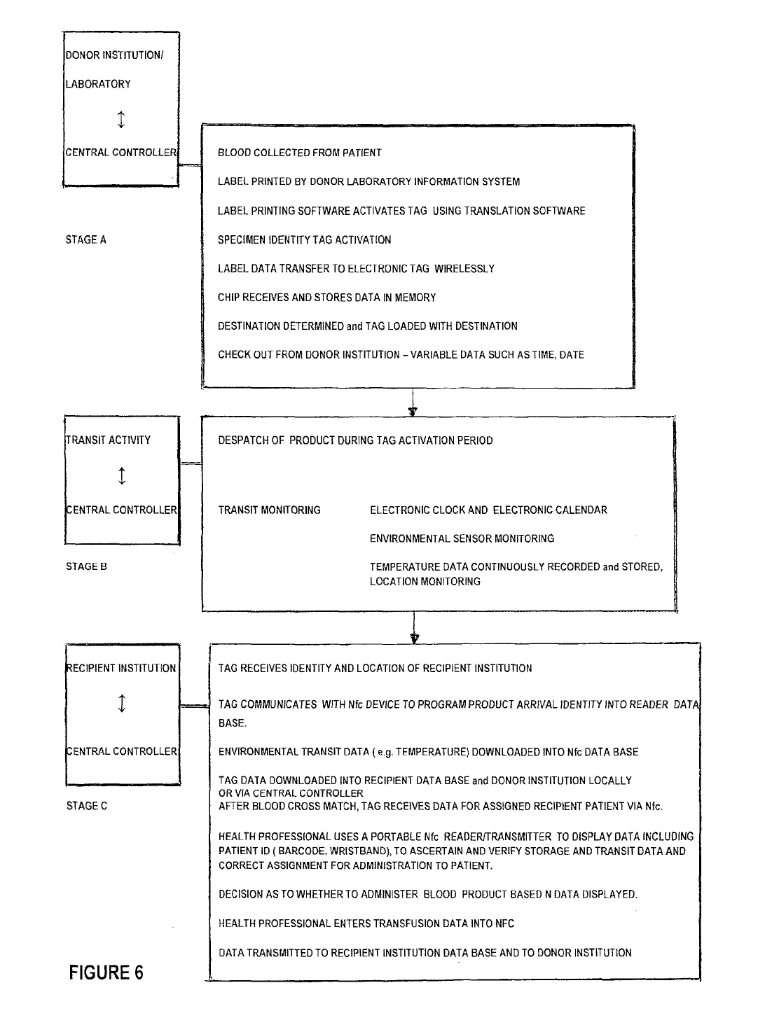

FIG. 6 shows a schematic layout of the system components of the invention according to one non limiting embodiment. The System and method shown in FIG. 6 is divided into three main processing stages. The first is the Donor institution activity, the second is the transit activity stage and the third is the recipient institution stage, respectively identified as stages A, B and C. Each Stage may either be linked to a central controller which is capable of transmitting and receiving data to and from each stage and/or each stage is linked to the subsequent stage or previous stages in the case of stages B and C. Thus Stage A is linked to Stage B, Stage B is linked to Stage C and Stage C is linked to Stage A. Stage B is also potentially linked to Stage A but is preferably linked to the recipient Stage C.

A typical but non limiting description of the processing is described below with reference to FIG. 6.

### Donor Institution/Stage A

A patient donates blood products at the donor institution. At collection it is critical from the beginning that donor data matches the sample. According to the method, at blood collection a label is printed by the donor laboratory information system. At the same time, label printing software activates the identity tag. This can be effected by use of a translation software. This allows transfer wirelessly of label information to the tag so that the tag now reflects data concerning the biological product. A chip associated with the tag stores the data in a memory. The data on the activated tag can also be uploaded to a central controller which is capable of monitoring a potentially unlimited number of products transiting from a donor institution to a recipient institution. Once a destination is determined, the tag is loaded with that data and is registered out from the donor institution including, time, date.

### Transit—Stage B

In stage B the product is transported to its pre designated destination and during this activity, the tag is ‘live” in that it is activated for storing and receiving more data such as location and temperature of the product. In transit, moveable product data is acquired and may be sent to the central controller and/or to the donor or recipient institution. The transit data includes temperature, time, location, date and other relevant data which is stored in the memory chip. Time is recorded using an electronic clock or other suitable timing software or hardware.

### Recipient—Stage C

On arrival at the destination, (hospital, blood bank or other institution) the bag is scanned so data in the memory is updated with the bags current new location. The bag's data concerning, identity, location and condition parameters are uploaded to the scanner enabling display of the transport temperatures so a user can determine if they have been within acceptable limits. Thus the scanner enables the user (nurse and like health personnel) that the particular blood products in the bag are acceptable for use on a particular patient whose ID will be included in the data. The electronic board incorporates a NFC or RFID, battery, memory temperature monitor/sensor, timer/clock, antenna and software. The portable scanner confirms bag for patient via barcode patient ID. The blood may then be delivered locally or to a remote location. Blood not used for one patient can potentially be used on another patient as the intelligence provides the data for safe decision making on use of the blood products. If the condition standards required is not reached the blood can be destroyed as per conventional practice for expired blood.

In stage C. the tag receives the identity and location of the recipient institution upon arrival. The tag communicates with an Nfc device to program product arrival data into a portable reader. Alternatively the product can be passed through a fixed scanner/reader. Tag data is downloaded into the recipient institution data base and if required the donor institution. This may be effected via a central controller or directly into the data base. The data is also loaded into a portable reader as described in FIGS. 4 and 5.

A cross match occurs and the product tag receives new data for the selected recipient patient via the Nfc. A health professional such as a nurse, using a portable reader similar to the type described in FIGS. 4 and 5, reads a display which provides historical data on the product such as donor name and temperature and storage history. This enables the nurse to ascertain and verify storage and transit data and correct assignment for administration to a patient. The nurse can then make a decision based on the data displayed as to whether administration of the blood is safe from the two perspectives that it is the correct match for the patient and has not expired or deemed to be expired if it has been reassigned. Once administered, the nurse enters the transfusion data into the Nfc data which is then transmitted to the donor and recipient institutions.

Once the intelligence is inserted into a preformed pocket, the bag is ready for data input and exchange. Preferably the pocket is sealed to prevent tampering or misuse, corruption of the data and to ensure the use can treat the data as reliable. Temperature sensors (preferably one or more probes) are included close to the contents to measure/monitor temperature as required. Nfc/RFID program starts a chip timer and loads data relevant to a particular bag. A second programmer tells bag where the bag is going.

The assembly described above has a number of advantages over the prior art arrangements which include the following:
1. Real time monitoring of medical agents, drugs and biological products including tracking of originating location, transit information and destination.
2. Real time condition monitoring.
3. The invention meets the needs of blood units, however, it is applicable to all blood components, as well as chemotherapy cocktails which are mixed off site for specific patients and can also be applied to IVIg products derived from human blood (or monoclonals as copies of human blood components), have a limited shelf life and are designed to be transfused into specific patients.

In use, controlling software allows a user to scan the chip/electronic board integrated with the container/bag to read locally the parameters of a bag and its contents to ascertain its history and whether the product remains suitable for continued or reallocated use. Input data may be uploaded by a local user or via a remote controlling station. A local user can display condition parameters and make judgments as to the quality and integrity of the product and therefore its suitability for use. This judgment may also be conducted at the remote control station—either on the premises where the bag and product are located or at another hospital for instance. Local reading can take place in a ward/theatre of a hospital or laboratory ‘base station’. Input of data can also be local or remote when required by a laboratory, hospital, donor service and/or relevant government body.

The present invention provides a biological products tracking system which includes an interactive biological products bag having associated with the bag, mobile interactive intelligence allowing the product to reveal or to be interrogated to reveal, what the product is, its transit path, its environmental condition such as temperature, who the donor is, who the recipient is, its origin, its destination, its capacity for re assignment if not used. This can be enabled by use of intelligent electronics integrated with the bag. Preferably a flexible RFID tag having a temperature sensor, chip, processor, battery, clock, calendar, secure read/write memory, Nfc unit, antenna. The Intelligent Blood Bag is used as part of an integrated Tag and Release software and hardware package which is capable of switching the bag on, loading it with the required data, monitoring its transport by time, temperature, destination, allocation to a specific patient or blood fridge within a hospital and informing a secure device handled by a health professional whether the blood unit is being dispensed to the correct patient. All data can be downloaded/uploaded to a computer system capable of communicating with the recipient institution such as a hospital, blood donor accreditation center and or central regulatory authority as required.

The tracking system can, in addition to its application to blood products, be applied to the tracking of chemotherapy cocktails which; i) are mixed off site for specific patients and can also be applied to IVIg products where they are items derived from human blood (or monoclonals as copies of human blood components); ii) have a limited shelf life and are designed to be transfused into specific patients. The present invention is also capable of use in Tag and Release technology used in the dispensing of medicines within a hospital. In a further application, the Tag and Release system can be employed to monitor components that are ‘implanted’ patients like Organ transplants, heart valves, pacemakers, insulin pumps etc.

It will be recognised by persons skilled in the art that numerous variations and modification may be made to the invention broadly described herein with out departing from the overall spirit and scope of the invention.

1. A method for tracking biological products from a source to a destination, the method comprising the steps of:
a) identifying and compiling data related to characteristics and identity of a product;
b) taking a container capable of holding the biological product and including with the container a device capable of transmitting and/or receiving and/or storing data related to the product;
b) uploading the data into the data storage device associated with the product;
c) providing at least one data reader capable of reading data stored in and/or transmitted from the storage device;
d) transporting the product from an origin to a predetermined destination; and
e) during transmission from the origin to the destination, monitoring location and condition parameters of the product.

2. A method according to claim 1 comprising the further step of verifying product identity and condition parameters of the product prior to administration of the biological product to a recipient.

3. A method according to claim 2 wherein the data is contained on a memory chip associated with a container which holds the biological product.

4. A method according to claim 3 wherein the data in the data storage device includes characteristics of the product and location history.

5. A method according to claim 4 wherein the characteristics of the product include type of product and condition parameters,

6. A method according to claim 5 wherein the condition parameters include at least temperature and age of the product.

7. A method according to claim 6 wherein the data includes the source of the biological product, the name of the donor, donor institution and the nature of the product.

8. A method according to claim 7 wherein the reader reads data transmitted from the storage device in real time.

9. A method according to claim 8 wherein the product tracking includes tracking of data related to place of origin, source of the product, name of donor, time of origination, transport path and destination.

10. A method according to claim 9 wherein the data further comprises the transport history, real time locations, path/route of travel, product transmission time.

11. A method according to claim 10 wherein a remote control station associated with at least a donor and recipient institutions receives and processes data related to the transit history and condition parameters of the biological product.

12. A method according to claim 11 wherein the source of the biological product is a blood donor.

13. A method according to claim 12 wherein the recipient of the biological product is a patient assigned to receive blood products.

14. A method according to claim 13 wherein the data included on the data storage device enables a practitioner to determine, using a data reader, at least origin, characteristics, condition parameters, historical location data of the product.

15. A method according to claim 14 wherein the biological product includes serum and/or packed cells.

16. A method according to claim 15 wherein the container is a blood bag and the electronic device is an RFID tag retained with the bag.

17. A method for tracking biological products held in a biological products container, from a source to a destination, the container including an electronic device, the electronic device capable of receiving, storing and transmitting/delivering data; and including:
an electronic readable memory,
an antenna, and
at least one power source, the antenna capable of receiving and transmitting data related to the nature and/or location and/or condition of biological products contained in the bag,
the method comprising the steps of:
a) identifying and compiling data related to characteristics and identity of a product;
b) taking a container capable of holding the biological product and including with the container the electronic device capable of transmitting and/or receiving and/or storing data related to the product;
b) uploading the data into the electronic data storage device associated with the product;
c) providing at least one data reader capable of reading data stored in and/or transmitted from the storage device;
d) transporting the product from an origin to a predetermined destination;
e) during transmission from the origin to the destination, monitoring location and condition parameters of the product; and
f) verifying condition parameters of the product prior to administration of the biological product to a recipient.

18. A method for tracking biological products from a source to a destination, using a biological products container including an electronic device capable of receiving, storing and transmitting/delivering data related t said products, the method comprising the steps of:
a) providing a software interface capable of automatically loading and initiating data logging;
b) providing a reader capable of reading from and writing to the electronic device;
c) using the reader to display product data and read and load patient identification data; and
d) providing a charging station which receives and retains said reader, for uploading data and charging said reader.

19. A biological products bag comprising; electronic data storage device capable of receiving, storing and transmitting/delivering data; the electronic device including:
an electronic readable memory,
an antenna, and
at least one power source; the antenna capable of receiving and transmitting data related to the nature and/or location and/or condition of biological products contained in the bag.

20. A biological products bag according to claim 19 wherein the power source is at least one battery.

21. A blood products bag for storing blood products, the bag including associated therewith an electronic device, a data storage memory, an electronic receiver including said data storage and having processing capability; the bag capable of transmitting data related to the nature and/or location and/or condition of biological product contained in the bag and receiving data of its condition transferred to its data base at any time receiving during the life of the blood products.

22. A biological products bag according to claim 21 wherein the data contained with the bag is readable direct form the bag via an electronic reader or readable remotely.

23. A biological products bag according to claim 22 wherein there is provided in or on the bag, an electronic chip allowing interactive transfer of data manually or automatically.

24. A biological products bag according to claim 23 wherein the data is downloaded or uploaded wirelessly or via hard wire connection to enable a user to ascertain the status of the bag and its contents.

25. A biological products bag according to claim 24 wherein the electronic intelligence includes a display monitor for user read out to ascertain condition and/or location parameters.

26-30. (canceled)
